(19) United States
(12) Patent Application Publication
(10) Pub. No.: US 2015/0001449 A1
(43) Pub. Date: Jan. 1, 2015

(54) Material with Designed Anisotropy When Consolidated

(71) Applicant: Evident Technologies, Troy, NY (US)

(72) Inventor: Clinton T. Ballinger, Burnt Hills, NY (US)

(21) Appl. No.: 14/317,472

(22) Filed: Jun. 27, 2014

Related U.S. Application Data
(60) Provisional application No. 61/840,626, filed on Jun. 28, 2013.

(51) Int. Cl. H01B 1/00; B29C 43/00

(52) U.S. Cl. CPC H01B 1/00; B29C 43/006
USPC 252/500; 264/319; 264/483; 264/604

(57) ABSTRACT

Disclosed herein are a consolidated material and a method of consolidating a mixture of materials. The method can include providing a first material with the first material being substantially fully crystallized. The method may also include providing a second material, wherein the second material is partially crystallized. The method may further include combining the first material and the second material into a mixed material and consolidating the mixed material into a consolidated material. Further disclosed is a consolidated material made according to this method.

### FIELD OF THE INVENTION

Embodiments of the present invention relate generally to methods of consolidating a mixed material, and a consolidated material made by such methods. The consolidated material may have a designed anisotropy based on the degree of crystallinity of the starting materials.

### BACKGROUND OF THE INVENTION

Semiconductor nanocrystals can be produced in a variety of ways. When they are produced in a colloidal suspension, they are often formed as connected atomic species but may fail to be completely crystalline, as they often do not form a perfect lattice structure. The nature of colloidal growth and suspension of nanocrystals leads to this imperfect lattice structure, as the different atomic species present can float through the solvent and attach themselves to the nanocrystal surface as it forms. The bonding site for the various atomic species may not be in line to make a perfect lattice structure that characterizes semiconductor materials. This lattice is important because it affects the electronic band structure of the material. In addition, unwanted or impurity atomic species are more easily pushed out of a perfect lattice structure and migrate to the surface of the nanocrystal, making them easier to get rid of during a subsequent washing step.

Semiconductor nanocrystals that are produced via colloidal methods are often not fully crystallized in the process; however, this degree of crystallinity can be controlled via the annealing process. Methods of controlling the crystallinity of a semiconductor nanocrystal powder can be found in co-pending application Attorney Docket No. EVID-0066-PV, (Serial No. to follow) the contents of which are hereby incorporated in their entirety. Such nanopowders may be used as the feed material in the consolidation process where the powder is placed into a die, for example, and heated. When heat and uniaxial pressure is applied to a material, anisotropic material properties may be induced. The uniaxial pressure gradient can cause this directionally dependent material behavior and may lead to micro cracks in the material and/or crystal structure that is directionally dependent. In previous embodiments, this has sometimes been considered a negative effect, as there was little or no control over the anisotropic properties induced.

### BRIEF DESCRIPTION OF THE INVENTION

Embodiments of the invention disclosed herein may include a method of consolidating a mixture of materials, the method comprising: providing a first material, the first material being substantially fully crystallized; providing a second material, the second material being partially crystallized; combining the first material and the second material into a mixed material; and consolidating the mixed material into a consolidated material.

Embodiments of the invention may also include a consolidated material made by a method of consolidating a mixture of materials, the method comprising: providing a first material, the first material being substantially fully crystallized; providing a second material, the second material being partially crystallized; combining the first material and the second material into a mixed material; and consolidating the mixed material into a consolidated material.

Embodiments of the invention may also include a consolidated material comprising: a mixture of materials with varying anisotropic properties along a single axis of the consolidated material.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1a illustrates a pillar of different materials to be consolidated according to some embodiments of the invention.

FIG. 1b illustrates a consolidated material from the pillar of different materials according to some embodiments of the invention.

FIG. 2 illustrates a consolidated material with varying degrees of crystallinity according to some embodiments of the invention.

It is noted that the drawings may not be to scale. The drawings are intended to depict only typical aspects of the invention, and therefore should not be considered as limiting the scope of the invention. In the drawings, like numbering represents like elements between the drawings. The detailed description explains embodiments of the invention, together with advantages and features, by way of example with reference to the drawings.

### DETAILED DESCRIPTION OF THE INVENTION

Embodiments of the present invention include methods of forming a material, as well as the material itself, that allow for control over the anisotropic properties by utilizing materials of varying crystallinity. Embodiments of the invention allow for a degree of control of the anisotropy by allowing for control of the crystallinity of the initial powder utilized prior to consolidation.

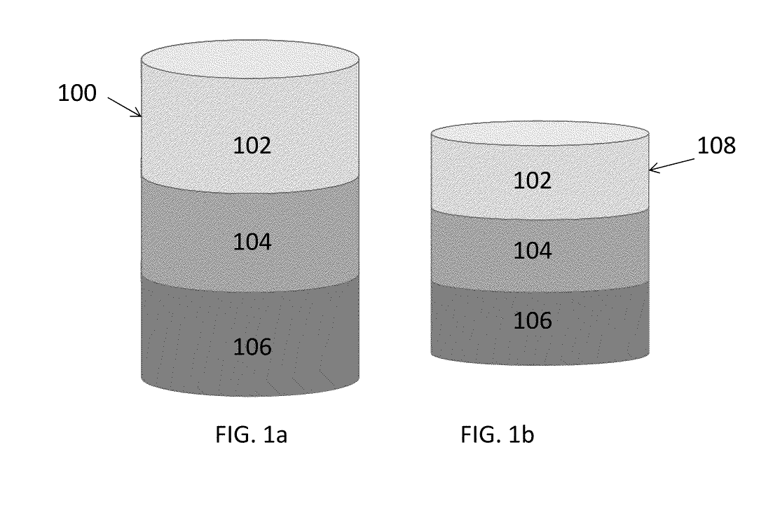

In one embodiment, a method of consolidating a mixture of materials is disclosed. The method, according to some embodiments, may include providing a first material, the first material being substantially fully crystallized, and providing a second material, the second material being partially crystallized. In previous consolidation techniques, as similarly illustrated in FIG. 1a and 1b, it has been found that utilizing only a fully crystallized material for layers 102, 104, and 106 for consolidation has led to anisotropic properties in the final material. When pillar 100 of layers 102-106 are fully crystallized, consolidated material 108 of layers 102-106 exhibits anisotropic properties. Anisotropic properties refer to a difference in a material's physical or mechanical properties when measured along one axis as compared to another axis. These differences in previous embodiments have often been viewed as negative effects on the consolidated material. For instance, using only fully crystallized materials frequently results in thermal and electrical properties that approach those of a bulk material system having a similar stoichiometry to the consolidated material, which is usually disadvantageous.

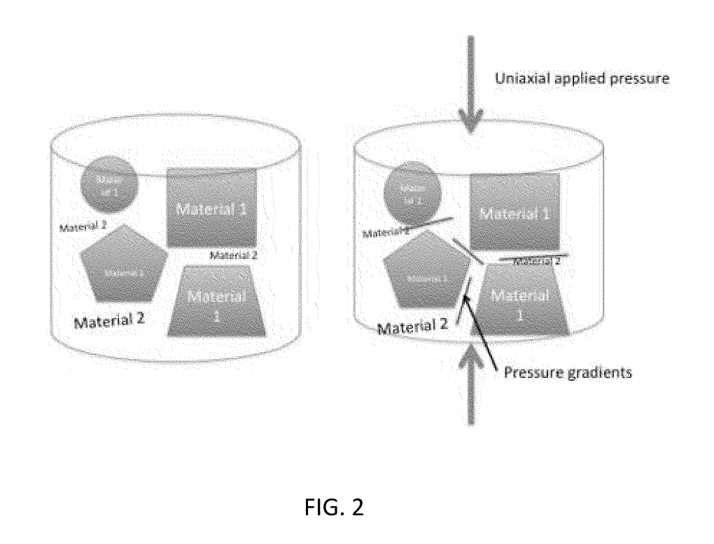

However, it has been found by the inventors that by utilizing different degrees of crystallinity of different starting materials, control of these anisotropic properties is gained. For instance, thermal and electrical properties can be altered based on the crystallinity of starting materials, as well as the parameters by which the material is consolidated. Due to the differences in crystallinity, regions within the consolidated material may exist, with the different regions exhibiting different anisotropic properties. Embodiments of the invention can utilize materials of different crystallinity in layers 102, 104, 106, or combinations thereof as illustrated in FIG. 1a and 1b, however, FIG. 2 illustrates such embodiments in further detail.

In some embodiments, these starting materials with varying levels of crystallinity can be combined into a mixed material. As illustrated in FIG. 2, the mixed material can include the fully crystallized first material. Though demonstrated as different shapes in FIG. 2, it should be understood that the first material may include substantially similar crystalline structures of one material, or different types of lattice structures, such as different shapes, of the same material. It should be further understood that the first material may actually comprise a plurality of crystallized materials of differing chemical makeup, which may also demonstrate variations in lattice structure. As illustrated on the left of FIG. 2, the second material provided may be packed around the first material. The second material may consist of a nanopowder, and the nanopowder may be substantially homogenous. In further embodiments, the second material may comprise a partially crystallized material, however, the powder may be in varying levels of cystallinity, and not just partially crystallized to the same degree. The second material may also be of different stoichiometrical materials, comprising a plurality of species in the same or varying levels of crystallinity.

It should also be understood that while the crystallinity of the first and second materials is differed, the chemical species of the first material and the second material may be the same or they may be of a different chemical species. Any or all of the disclosed materials may include semiconductor nanocrystals and/or quantum dots, as colloidal suspensions or in a dried powder form. These materials may have been colloidally synthesized.

Following mixing of the first and second materials, the resulting mixed material may be consolidated into a consolidated material. This consolidation can include any known or later developed methods of consolidation. For instance, the consolidation may include, but is not limited, to a method including hot pressing, spark plasma sintering, hot isostatic pressing, or a combination thereof. These processes typically involve either heat, pressure, or a combination of heat and pressure, applied to the mixed material, often provided within a die. These consolidation techniques may include pressure, which can be applied uniaxially, or along one axis, as illustrated on the right of FIG. 2. The inventors have found that although the pressure is applied uniaxially and externally, by varying the crystallinity of the first and second materials, regions of localized pressure, as measured by both direction and magnitude of the pressure, exist during consolidation. As illustrated by the lines in the spaces between portions of the first material, the pressure applied may result in localized gradients of pressure during consolidation, shown in different directions than the uniaxial applied pressure. Though not illustrated, it should be understood that the magnitude of the pressure may also vary.

This localized application of pressure is a result of the varying degrees of crystallinity of the first and second materials. The interaction between different levels of cystallinity appears to affect the pressure between all particles of the mixed material being consolidated. Such a variation in pressure has been found to allow for differing levels of anisotropy throughout the consolidated material. As opposed to previous methods, which resulted in a very single direction variation in anisotropic properties along the uniaxial pressure application line, a consolidated material according to the disclosed methods results in varying anisotropic properties, including directional variations that include axes other than that along which pressure was applied, and the magnitude of the anisotropic properties in multiple directions.

It should also be understood that the layer illustrated in FIG. 2, including the first material and the second material, may be used as illustrated in FIG. 1a, wherein one or all of layers 102-106 may comprise such a layer, and each layer 102-106 may include the same or different chemical compositions, levels of crystallinity, or lattice structures. In these embodiments, one or multiple layers 102-106 of FIG. lb, following consolidation, can exhibit a controlled variation of anisotropic properties in multiple directions, the same of varying for each of layers 102-106.

In a further embodiment, a consolidated material is disclosed. This consolidated material may be made by any of the above disclosed methods of consolidating a mixture of materials.

In a further embodiment, a consolidated material is disclosed which comprises a mixture of materials with varying anisotropic properties along a plurality of axes of the consolidated material. The varying anisotropic properties may include at least one of a variation in direction of anisotropy and a variation in magnitude of anisotropy.

The foregoing description of various aspects of the invention has been presented for the purpose of illustration and description. It is not intended to be exhaustive or to limit the invention to the precise form disclosed, and obviously, many modifications and variations are possible. Such variations and modifications that may be apparent to one skilled in the art are intended to be included within the scope of the present invention as defined by the accompanying claims.

What is claimed:

1. A method of consolidating a mixture of materials, the method comprising:
providing a first material, the first material being substantially fully crystallized;
providing a second material, the second material being partially crystallized;
combining the first material and the second material into a mixed material; and
consolidating the mixed material into a consolidated material.

2. The method of claim 1, wherein the first material and the second material comprise a single species, and wherein a crystallinity of the first material and the second material are different.

3. The method of claim 1, wherein the first material and the second material comprise different species, and wherein a crystallinity of the first material and the second material are different.

4. The method of claim 1, wherein the consolidating comprises at least one method chosen from a group consisting of: hot pressing, spark plasma sintering, and hot isostatic pressing.

5. The method of claim 1, wherein the consolidated material has varying anisotropic properties throughout the consolidated material.

6. The method of claim 5, wherein the varying anisotropic properties include at least one of a variation in direction of anisotropy and a variation in magnitude of anisotropy.

7. A consolidated material made by a method of consolidating a mixture of materials, the method comprising:
providing a first material, the first material being substantially fully crystallized;
providing a second material, the second material being partially crystallized;
combining the first material and the second material into a mixed material; and
consolidating the mixed material into a consolidated material.

8. The consolidated material of claim 7, wherein the first material and the second material comprise a single species, and wherein a crystallinity of the first material and the second material are different.

9. The consolidated material of claim 7, wherein the first material and the second material comprise different species, and wherein a crystallinity of the first material and the second material are different.

10. The consolidated material of claim 7, wherein the consolidating comprises at least one method chosen from a group consisting of: hot pressing, spark plasma sintering, and hot isostatic pressing.

11. The consolidated material of claim 7, wherein the consolidated material has varying anisotropic properties throughout the consolidated material.

12. The consolidated material of claim 11, wherein the varying anisotropic properties include at least one of a variation in direction of anisotropy and a variation in magnitude of anisotropy.

13. A consolidated material comprising:
a mixture of materials with varying anisotropic properties along a plurality of axes of the consolidated material.

14. The consolidated material of claim 13, wherein the varying anisotropic properties include at least one of a variation in direction of anisotropy and a variation in magnitude of anisotropy.
